(19) United States
(12) Patent Application Publication
(10) Pub. No.: US 2026/0328736 A1
(43) Pub. Date: Oct. 22, 2026

(54) UNIVERSAL FITTING FOR CHROMATOGRAPHY COLUMNS

(71) Applicant: Waters Technologies Corporation, Milford, MA (US)

(72) Inventors: Charles T. Murphy, Norton, MA (US); Michael Zagieboylo, Hanover, MA (US)

(21) Appl. No.: 19/530,948

(22) Filed: Feb. 5, 2026

Related U.S. Application Data
(60) Provisional application No. 63/759,964, filed on Feb. 18, 2025.

(51) Int. Cl. G01N 30/60

(52) U.S. Cl. CPC G01N 30/6026; G01N 30/6047; G01N 30/6078

(57) ABSTRACT

A fitting assembly for coupling to a chromatography system comprises a chromatographic column; a sleeve constructed and arranged for positioning about the chromatography column; a polymer seal having an outer diameter directly abutting a distal end of the sleeve; and a stainless steel collar positioned about the polymer seal and the distal end of the sleeve, the collar having a hole at an inner diameter that is less than the outer diameter of the polymer seal in an uncompressed state, wherein the polymer seal is press-fit against the distal end of the sleeve in the hole of the collar to reduce the outer diameter of the seal in a compressed state to form a fluid-tight seal between the polymer seal and the inner diameter of the collar by a radial force applied by the seal against the collar.

### RELATED APPLICATION

This application claims priority to U.S. Provisional Patent Application No. 63/759,964 filed on Feb. 18, 2025 and titled “Universal Fitting for Chromatography Columns” the entirety of which is incorporated by reference herein.

### FIELD OF THE PRESENT DISCLOSURE

The disclosed technology generally relates to a chromatography apparatus that operates at high pressures. More particularly, the disclosed technology relates to fittings for providing pressure-tight seals between nanoscale chromatography columns, valves, pumps, and analytical instrumentation.

### BACKGROUND

Chromatography columns are well-known for separating a fluid sample into constituent components as the mobile phase containing the sample passes from a sample loop through the column to a detection device, for example, a light scattering instrument.

It is desirable that columns are universal, or more specifically, compatible with connectors which provide fluidic connections to various apparatus components, such as a port of a mass spectrometry source, liquid chromatography instrument, or the like.

### BRIEF DESCRIPTION OF THE DRAWINGS

Advantages of the present disclosure may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the present disclosure.

FIG. 1 is a block diagram of a chromatography system which may be configured to operate with embodiments of the present disclosure.

FIG. 2A is an exploded perspective view of a fitting assembly for coupling to a chromatography system, in accordance with some embodiments.

FIG. 2B is a cross-sectional view of the fitting assembly of FIG. 2A.

FIG. 2C is a blowup view of a distal end of the fitting assembly of FIGS. 2A and 2B.

FIG. 2D is an exploded cross-sectional view of the distal end of the fitting assembly of FIGS. 2A-2C.

FIG. 3 is a cross-sectional view of the fitting assembly of FIGS. 2A-2D in a port of a first chromatography system, in accordance with some embodiments.

FIG. 4 is a cross-sectional view of the fitting assembly of FIGS. 2A-2D in a port of a second chromatography system, in accordance with other embodiments.

FIG. 5 is a cross-sectional view of a fitting assembly of FIGS. 2A-2D in a port of a third chromatography system, in accordance with other embodiments.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments of the present inventive concept include a connector assembly for connecting various columns, valves, pumps, and modules to ports of various chromatography systems provided by different manufacturers. The connector assembly includes a fitting assembly that may be crimped to one or both ends of a fused silica nanocolumn capillary for removably attaching the capillary to a chromatography column, chromatography valve, autosampler, fraction collector, detector, and/or other related instruments. The fitting assembly may be universal in that it can provide an interface to many different ports of various nano, capillary, and micro-liquid chromatography applications.

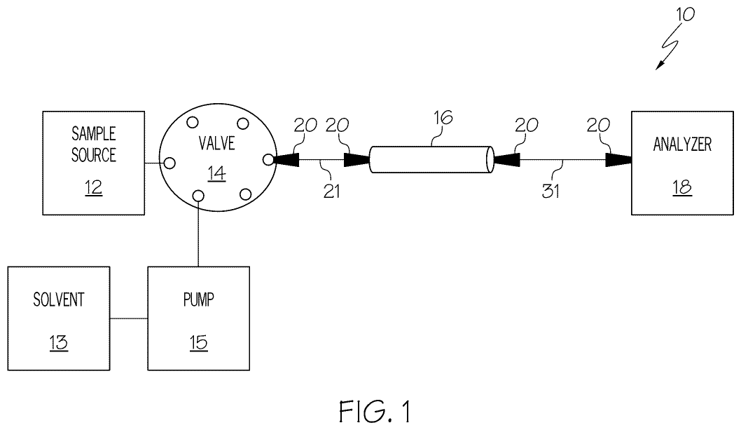

FIG. 1 is a block diagram of a chromatography system 10 which may be configured to operate with embodiments of the present disclosure. The chromatography system 10 may include components allowing for operations related to high performance liquid chromatography (HPLC), ultra performance liquid chromatography (UPLC), or other separation technique.

During operation, a sample mixture may be transferred from a sample source via a mobile phase to a chromatographic column 16 via a port of a valve 14 at a high pressure. Another valve port may communicate with a flow controller 15 that regulates the flow rate of the mobile phase and sample through the chromatographic column 16, ensuring accurate and consistent separation of analytes for analysis. The column 16 separates the sample mixture into its individual constituents and separates them into distinct fractions as they elute from the column 16 and are output to a fraction analyzer 18 and/or other analysis system.

The sample flow path includes a first capillary 21 extending from the valve 14 to the input end of the column 16 and a second capillary 31 extending from the output end of the column 16 to the analyzer 18. In some embodiments, the first capillary 21 and/or the second capillary 31 is a nanocolumn capillary. Accordingly, each capillary 21 or 31 may have a fitting assembly 20 at one or both ends. The capillaries 21, 31 and/or their fitting assemblies 20 may have different or varying dimensions for providing a seal-tight connection to either or both ends of the column 16, a port of the valve 14 or other element of a liquid chromatography system \and/or the analyzer 18, e.g., a port of a mass spectrometry system. For example, capillary 21 may be 40 microns and capillary 31 may be 60 microns, but not limited thereto.

Any region of the entire fluidic pathway in the chromatography system 10 may include a combination of capillaries and corresponding fitting assemblies 20 to improve chromatographic results.

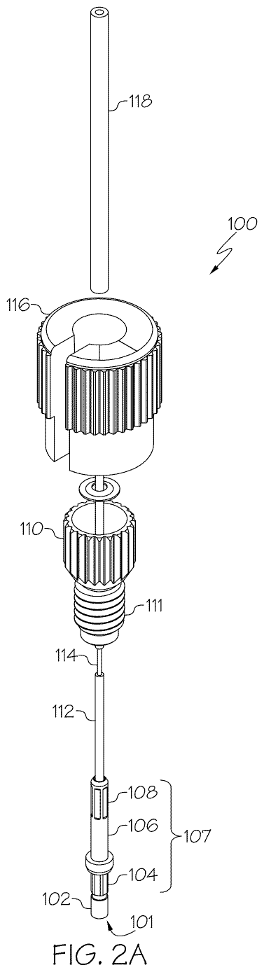

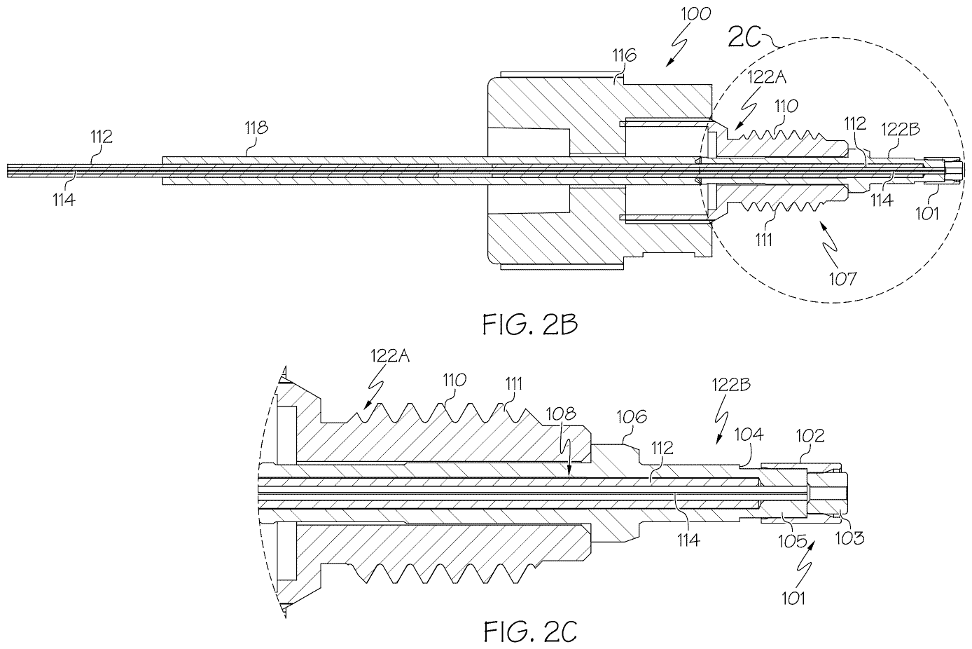

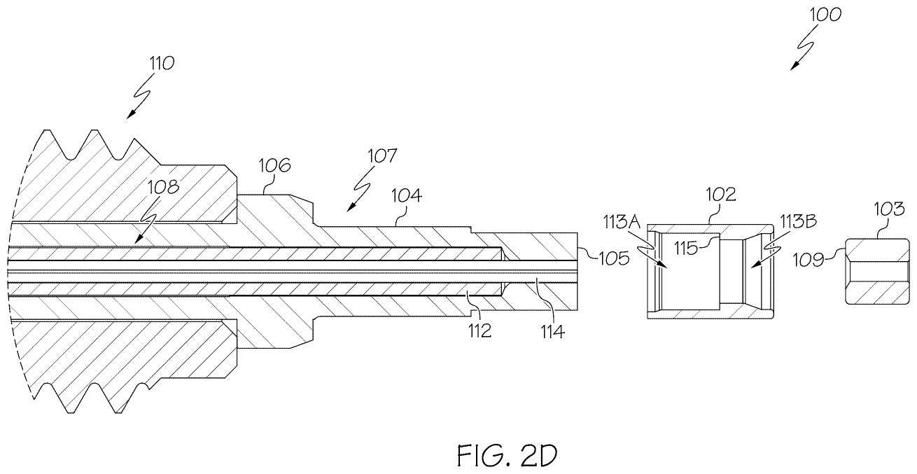

FIGS. 2A-2D are views of a fitting assembly 100 for coupling to a chromatography system, in accordance with some embodiments. The fitting assembly 100 may be the same as or similar to fitting assemblies 20 shown and described in FIG. 1. For example, the fitting assembly 100 may serve as an inlet and/or an outlet of a fused silica capillary 21, 31, or the like. The fitting assembly 100 may be constructed to withstand pressures of up to 15,000 psi, but not limited thereto.

In some embodiments, the fitting assembly 100 for coupling to a chromatographic column comprises a knob 116, a tubular shaft sleeve 118, a threaded fitting 110, a sleeve 107, and a tip 101 at a distal portion 105 of the sleeve 107. In some embodiments, the sleeve 107 is a ferrule. The knob 116 may be constructed and arranged to allow a user to hand-tighten the fitting assembly 100 into a threaded port, e.g., at an end of the column 16, the valve 14, etc. until a fluid-tight seal is formed between the fitting assembly 100 and the port.

The shaft sleeve 118 extends through the knob 116. The shaft sleeve 118 may be hollow and may have a lumen through which a polyether ether-ketone (PEEK) tube 112 about a fused silica capillary 114 extends. In some embodiments, the shaft sleeve 118 is formed of heat shrink tubing that functions as a strain relief where the tubing exits the fitting 108. The shaft sleeve 118 itself may not be crimped. The PEEK tube 112 and fused silica capillary 114 may collectively be referred to as a capillary or column capillary.

The fitting 110 may be hollow, and may have a lumen where the column capillary comprising the PEEK tube 112 and fused silica capillary 114 further extend. In some embodiments, the fitting 110 includes a threaded region 111 and a region proximal the threaded region 111 that includes at least one radial crimp 122A for coupling the fitting 110 to the tubular portion 108 of the sleeve 107, referred to as part of the fitting or fitting portion of the sleeve 107, in which a portion of the chromatographic column comprising the PEEK tube 112 and fused silica capillary 114 may be positioned. More specifically, the crimps 122 hold the assembly together and form a seal between the capillary and fitting 108.

The sleeve 107 may be formed of a material such as stainless steel or the like, and can have three regions: a distal region 104, a mid-region 106, and a proximal region 108. These regions 104, 106, 108 can be formed of a single stock of material and machined to form their dimensions as well as a hole extending through the length of the sleeve 107. The proximal region 108 may be constructed and arranged for insertion in the threaded fitting 110. The mid region 106 has a greater width than the proximal region and may be constructed and arranged for directly abutting the distal end of the fitting 110 and to hold the sleeve 107 in place against the fitting 110. The column capillary comprising the PEEK tube 112 and fused silica capillary 114 can extend from the fitting 110 through the hole in the sleeve 107. The distal region 104 of the sleeve 107 may include at least one radial crimp 122B for coupling the sleeve 107 to a distal portion of the chromatographic column comprising the PEEK tube 112 and fused silica capillary 114 is positioned. In some embodiments, this second crimp 122B complements the first crimp 122A described above. The crimps 122A, 122B can provide radial seal at one or more longitudinal locations on the fitting assembly 100, in particular, to deform and compress at one location the distal region 104 of the sleeve 107 onto the capillary 112, 114 and at another location the fitting 110 onto to the proximal region 108 of the sleeve 107, which in turn compresses against the capillary 112, 114 to form high pressure liquid tight seals between these various elements of the fitting assembly 100.

The tip 101 includes a collar 102 and a seal 103. In some embodiments, the collar 102 is formed of stainless steel and the seal 103 is formed of a polymer such as polyimide or related plastic or other compliant material that permits the stainless steel collar 102 to be positioned about the polymer seal and the distal end of the sleeve 107. The collar 102 has a hole 113A, 113B (generally 113) that extends through the length of the collar 102. The hole has a first portion 113B at an inner diameter that may be less than the outer diameter of the polymer seal 102 in an uncompressed state. When assembled, the polymer seal 103 may be press-fit against the distal end 105 of the sleeve 107 in the hole 113 of the collar 102 to reduce the outer diameter of the seal 103 in a compressed state to form a fluid-tight seal between the polymer seal 103 and the inner diameter of the collar 102 by a radial force applied between the seal 103 and the collar 102. Also, the seal 103 not only seals at the outside diameter in the collar (102), but it also seals by axial compression against the fitting face 105 and the flat bottom of the ports.

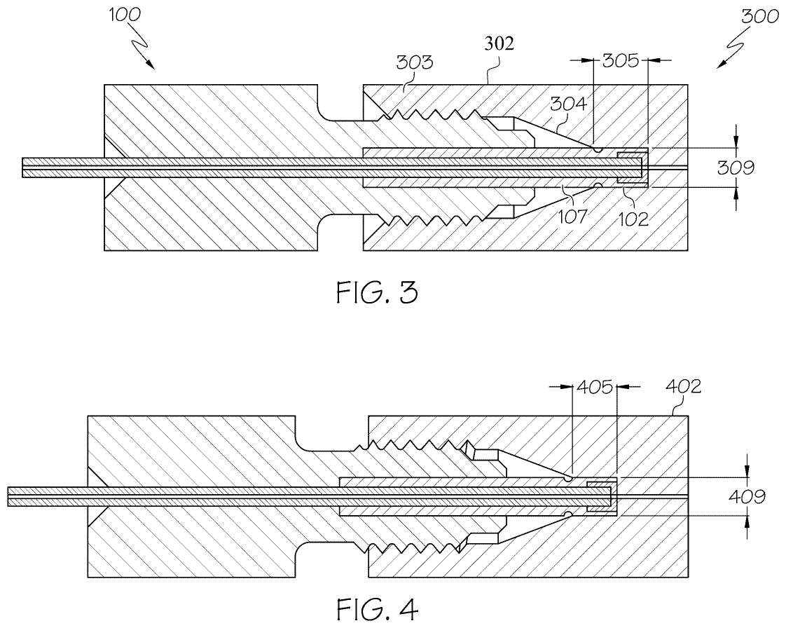

The collar hole has a second portion 113A for receiving and securing the distal end 105 of the sleeve 107 when press-fit. The collar 102 has a shoulder 115 in its interior that directly abuts the corners of the distal end 105 of the sleeve 107 when the collar 102 is press-fit. This configuration prevents the distal end 105 of the sleeve 107 from extending to the polymer seal 103 in the first portion 113B of the hole. At least a majority of the polymer seal 103 may be positioned inside the collar 102. The collar 102 can limit the amount of compression of the polymer seal inside the collar 102 and against the sleeve 107. When the polymer seal 103 has a diameter or related dimension that may be the same as or similar to the port in which it is inserted, for example, shown in FIGS. 3-5, this can reduce or prevent over compression of the polymer seal 103. As described herein, a fluid seal occurs at the outside diameter of the seal between it and the collar. More specifically, the polymer seal 102 in the compressed state may be less than a diameter of a diameter of the distal end of the sleeve to form the seal and form the radial force of the seal. In other embodiments, a fluid-tight seal is at both end faces of the seal, on the left side between it and the ferrule/sleeve and on the right side at the bottom of the fitting it is installed in. For example, the fitting face 105 of the ferrule inserted in the hole 113A of the collar 102 can directly abut, and form a fluid-tight seal by axial compression against the flat face 109 of the seal 103, and also at the right side of the seal 103 a fluid-tight seal may be formed with the end or bottom of the fitting (not shown) or port that it is coupled to.

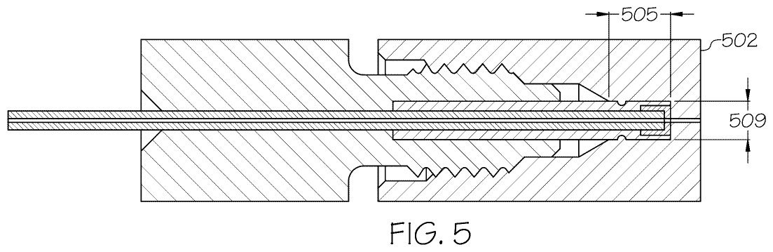

FIGS. 3-5 are cross-sectional views of the fitting assembly 100 of FIGS. 2A-2D removably coupled to ports of various chromatography systems, in accordance with some embodiments. In FIG. 3, the fitting assembly 100 may be inserted, or threaded, in the port 302 of a first chromatography system 300. The port 302 has a threaded proximal region 303, a distal region 305, and a tapered region 304 that transitions from the proximal region 303 to the distal region 305. The dimensions of the collar 102, in particular, the length and width, are such that the collar 102 and polymer seal 103 attached to the distal end 105 of the sleeve 107 can be inserted into the distal region 305 of the chromatography port 302 and a fluid-tight seal formed therein. The width or diameter of the seal 103 may be the same, or uniform, along the length of the seal 103 positioned in the collar 102. FIGS. 4 and 5 illustrate other port configurations. However, the collar 102 and polymer seal 103 attached to the distal end 105 of the sleeve 107 can be inserted into the distal region 405 of the chromatography port 402 of FIG. 4 or the distal region 505 of the chromatography port 502 because the length and width of the collar 102 can accommodate the length 405, 505 and width 409, 509, of the ports 402, 502, respectively. Accordingly, this arrangement and dimension of the collar 102, seal 103, and sleeve 107, especially with the outer diameter of the collar 102 and the positive stop formed by the shoulder 115 in the interior of the collar 102 permit the fitting assembly 100 to universally connect to a wide range of different nano liquid chromatography ports and other nanocolumn ports with near zero dead volume.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A fitting assembly for coupling to a chromatography system, comprising:
a column capillary;
a sleeve constructed and arranged for positioning about the column capillary;
a polymer seal having an outer diameter directly abutting a distal end of the sleeve; and
a stainless steel collar positioned about the polymer seal and the distal end of the sleeve, the collar having a hole at an inner diameter that is less than the outer diameter of the polymer seal in an uncompressed state, wherein the polymer seal is press-fit against the distal end of the sleeve in the hole of the collar to reduce the outer diameter of the seal in a compressed state to form a fluid-tight seal between the polymer seal and the inner diameter of the collar by a radial force applied by the seal against the collar.

2. The fitting assembly of claim 1, wherein the column capillary comprises:
a fused silica capillary; and
a polyether ether-ketone (PEEK) tube about the capillary, wherein the sleeve includes at least one radial crimp for coupling the sleeve to the PEEK tube.

3. The fitting assembly of claim 1, further comprising a fitting having a hole where the column capillary and a tubular portion of the sleeve are positioned, wherein the fitting includes at least one radial crimp for coupling the fitting to the tubular portion of the sleeve.

4. The fitting assembly of claim 1, wherein a compressed seal diameter of the seal in the compressed state is less than a sleeve diameter of the distal end of the sleeve to form the seal and form the radial force of the seal.

5. The fitting assembly of claim 1, wherein the inner diameter of the collar has a first diameter for receiving the polymer seal and a second diameter greater than the first diameter for positioning over the distal end of the sleeve, wherein the seal has a length that is greater than a length of the first diameter of the inner diameter of the collar, and where the collar further comprises a shoulder between the first diameter and the second diameter to prevent an over compression of the polymer seal is press-fit against the distal end of the sleeve in the hole of the collar.

6. The fitting assembly of claim 1, wherein the collar, the seal, and the sleeve are dimensioned for forming a fluid path between the column capillary and an ultra-performance liquid chromatography port or column.

7. The fitting assembly of claim 1, wherein the seal has a through hole constructed and arranged to be aligned along and concentric with the fluid path of the column capillary, the through hole having a uniform diameter along the length of the seal for receiving and outputting a volume of fluid.

8. The fitting assembly of claim 1, wherein at least a majority of the polymer seal is positioned inside the collar.

9. A fitting assembly for coupling to a chromatographic column, comprising:
a knob;
a shaft sleeve extending from the knob, the sleeve constructed and arranged for positioning about the chromatography column;
a threaded fitting coupled to the knob;
a sleeve having a proximal portion extending through the threaded fitting, wherein the threaded fitting includes at least one radial crimp for coupling the threaded fitting to the sleeve;
a tip at a distal portion of the sleeve, the tip comprising:
a polymer seal having an outer diameter;
a stainless steel collar having a hole at an inner diameter that is less than the outer diameter of the polymer seal, wherein the polymer seal is press-fit in the hole of the collar to reduce the outer diameter of the polymer seal to the inner diameter of the collar.

10. The fitting assembly of claim 9, wherein the chromatographic column comprises:
a fused silica capillary; and
a polyether ether-ketone (PEEK) tube about the capillary, wherein the sleeve includes at least one radial crimp for coupling the sleeve to the PEEK tube.

11. The fitting assembly of claim 10, wherein the threaded fitting has a hole where the fused silica capillary, the PEEK tube, and the proximal portion of the sleeve are positioned, wherein the at least one radial crimp couples the fitting to the proximal portion of the sleeve.

12. The fitting assembly of claim 9, wherein the polymer seal in the compressed state is less than a diameter of a diameter of the distal end of the sleeve to form the seal and form the radial force of the seal.

13. The fitting assembly of claim 9, wherein the inner diameter of the collar has a first diameter for receiving the polymer seal and a second diameter greater than the first diameter for positioning over the distal end of the sleeve, wherein the seal has a length that is greater than a length of the first diameter of the inner diameter of the collar, and where the collar further comprises a shoulder between the first diameter and the second diameter to prevent an over compression of the polymer seal is press-fit against the distal end of the sleeve in the hole of the collar.

14. The fitting assembly of claim 9, wherein the collar, the seal, and the sleeve are dimensioned for forming a fluid path between the column capillary and an ultra-performance liquid chromatography port or column.

15. The fitting assembly of claim 9, wherein the seal has a through hole constructed and arranged to be aligned along and concentric with the fluid path of the column capillary, the through hole having a uniform diameter along the length of the seal for receiving and outputting a volume of fluid.

16. The fitting assembly of claim 9, wherein at least a majority of the polymer seal is positioned inside the collar.

17. A method for coupling a nanocolumn capillary to a fitting assembly, comprising:
positioning a distal portion of a sleeve in a threaded fitting;
forming at least one radial crimp at the threaded fitting for coupling the threaded fitting to the sleeve;
positioning a polymer seal at a distal end of the sleeve, the polymer seal having an outer diameter;
press-fitting a stainless steel collar about the polymer seal, the stainless steel collar having a hole at an inner diameter that is less than the outer diameter of the polymer seal; and
in response to the press-fitting, reducing the outer diameter of the polymer seal to the inner diameter of the collar.

18. The method of claim 17, further comprising:
forming a first fluid-tight seal between a first side of the polymer seal and the distal end of the sleeve; and
forming a second fluid-tight seal between a second side of the polymer seal and a port into which the polymer seal is inserted.

19. The method of claim 17, wherein the threaded fitting has a hole where the nanocolumn capillary and the proximal portion of the polymer sleeve are positioned, and wherein the at least one radial crimp couples the fitting to the proximal portion of the sleeve.

20. The method of claim 17, wherein the polymer seal has a through hole constructed and arranged to be aligned along and concentric with the fluid path of the column capillary, the through hole having a uniform diameter along the length of the seal for receiving and outputting a volume of fluid.
